(19) United States
(12) Patent Application Publication
(10) Pub. No.: US 2011/0023475 A1
(43) Pub. Date: Feb. 3, 2011

(54) TRANSMISSION WITH A TRANSMISSION HOUSING

(75) Inventor: Jörg Busch, Konigsbronn-Zang (DE)

Correspondence Address: BAKER & DANIELS LLP;111 E. WAYNE STREET, SUITE 800, FORT WAYNE, IN, 46802, US

(73) Assignee: VOITH PATENT GMBH, Heidenheim (DE)

(21) Appl. No.: 12/918,866

(22) PCT Filed: Feb. 24, 2010
(86) PCT No.: PCT/EP2010/001142

§ 371 Date: Oct. 12, 2010

(30) Foreign Application Priority Data
Feb. 28, 2009 (DE) 10 2009 011 041.0

(51) Int. Cl. F16D 33/18; B22D 17/20

(52) U.S. Cl. 60/361; 164/47

(57) ABSTRACT

The invention relates to a transmission with a transmission housing and at least one hydrodynamic component, of which at least one region is arranged in an integral manner with the transmission housing of the hydrodynamic component. The transmission housing is arranged in a substantially tubular way with an opening at each end. The region of the hydrodynamic component which is arranged integrally with the transmission housing is arranged as a functional element of the hydrodynamic component and arranged between the openings. The inner cross section of the transmission housing is arranged to be constant or expanding from the functional element to the respective opening. The transmission housing can thus be demolded in a simple manner and can be cast without any lost cores in permanent molds.

The invention relates to a transmission with a transmission housing and with at least one hydrodynamic component, of which at least one section is arranged to be integral with the transmission housing. The invention further relates to a method for producing a transmission housing for such a transmission.

Generic automatic transmissions are generally known. Reference by way of example is made here to DE 20 21 543 A1 which describes a combined hydrodynamic/mechanical transmission for vehicles with splitting of the traction power by means of a differential on one power path with a hydrodynamic converter and a mechanical power path which is disposed parallel thereto, and with the combining of the traction power to one common power path. The transmission comprises mechanical speed steps (gears) which can be switched on and off selectively in the hydrodynamic and/or mechanical and/or in the common power path.

These so-called differential converter transmissions are used in the drive of vehicles of various kinds. Several planetary gear sets are used in such a transmission, as is usually the case in all automatic transmissions. These planetary gear sets are connected with one another in a predetermined fixed coupling scheme. The different gear steps of the transmission are realized with multi-disk clutches or multi-disk brakes. Shifting without any interruption in the tractive power is typically achieved with the disks of the clutches or brakes.

In many such transmissions with power splitting, the hydrodynamic converter and/or other hydrodynamic components such as hydrodynamic couplings or wear-free permanent brakes in the from of retarders are integrated in the transmission and thus also in the transmission housing.

In particular, the outer shell of the hydrodynamic component can be integrated entirely or partly in the transmission housing.

A turbo transmission is known from the older DE 10 2008 011 386, in which not only the outer shell of a hydrodynamic component but also a bladed stator is formed as a functional element of a hydrodynamic component in an integral fashion with the transmission housing. The transmission housing itself is arranged to be divisible along a plane extending through the axis of the hydrodynamic component in order to enable the mounting of the hydrodynamic components.

These types of transmissions in which parts of the hydrodynamic components are arranged to be integrated in the transmission housing always have the disadvantage that they are arranged in a distinctly complex manner with respect to their production. The usual production of such components therefore consists of a casting method with lost molds, e.g. sand casting, which can reflect the complex shapes of the transmission housing which comprises several undercuts, in order to realize this casting technique.

This production method comes with two decisive disadvantages. The method with lost molds is relatively expensive. Moreover, sand casting merely offers are comparatively low surface quality because a certain surface roughness will always remain as a result of the graining of the sand, which depending on the application requires a respective after-treatment of the surfaces.

It is now the object of the present invention to improve a transmission with a transmission housing in the respect that the simplest possible and most efficient production of the transmission housing is enabled in combination with a simple and efficient mounting of the same.

This object is achieved in accordance with the invention by the features mentioned in the characterizing part of claim 1.

In accordance with the invention, the transmission housing is arranged in a substantially tubular way with openings at both ends, which means it is not divided in a plane intersecting the axis of the hydrodynamic component. Furthermore, the region of the hydrodynamic component which is arranged in an integral manner with the transmission housing is arranged in this case as a functional element of the hydrodynamic component and not merely as a shell. This functional element of the hydrodynamic component is arranged in the transmission housing between the two openings. The inner cross section of the transmission housing is arranged to be the same or expanding, starting from the functional element towards the respective opening. The transmission housing can be removed from the mold very easily as a result of this cross section which remains the same or expands from the functional element to the respective openings, which cross section is thus free from undercuts. It is especially possible to avoid lost cores which would be necessary in order to represent undercuts which do not occur here in accordance with the invention. The transmission housing of the transmission in accordance with the invention can thus be produced very simply and cheaply in permanent molds such as gravity dies or die-casting molds, if economically viable in respect of the required piece numbers. The transmission housing per se is arranged as an integral part which is substantially tubular. This one part can then be sealed at its two ends by respective covers or the like. The transmission housing in accordance with the invention as a cast product comprises the largest part of the length of the entire transmission structure, whereas the cover assumes an only small part of the length. Typically, more than 97%, but at least 90% to 95%, of the length enclosed by the transmission housing lies within the cast integral transmission housing which also comprises the functional elements of the hydrodynamic component. The covers are then substantially planar and no longer tubular, and typically comprise only a minimum part of the length enclosed by the transmission housing, typically less than 3%, and maximally 5 to 10%, of the enclosed entire length.

The functional element shall be understood as being an element within the terms of the invention which influences the flow in the hydrodynamic component. By integrating the at least one functional element, it can also be produced in the one production step, so that it is possible to omit additional molds for such a functional element, especially a guide wheel of a hydrodynamic converter, and preferably the guide wheel together with the fixed guide blades. It can thus be produced together directly in the production of the transmission housing.

As a result of casting in a permanent mold, especially a die-casting mold or a gravity die, a very good surface quality is further achieved in comparison with lost molds with sand cores. Moreover, rapid cooling and thus rapid solidification of the melt is achieved as a result of the rapid thermal conductivity of the gravity die or the die-casting mold, so that a very fine-grained structure of high strength is obtained in addition to the high-quality surface.

The configuration thus allows in the advantageous arrangement to produce a functional element of a hydrodynamic component and especially preferably a guide wheel integrally arranged with guide blades with sufficiently high surface quality so that no after-treatment of the typically very complex shapes of the guide wheel and guide blades is necessary.

A further advantage can be achieved in this especially preferred embodiment of the transmission in which the guide wheel is arranged in an integral manner with the guide wheel blades and in an integral manner as a functional element with the transmission housing. Since the guide blades need not be finished, there can be a very free configuration of the guide blades because they need not be accessible at all points as a result of machining. The guide blades can thus be adjusted ideally to the hydraulic conditions because the only constructional precondition lies in the demoldability from the permanent mold and because there are no limitations in the shaping as a result of after-treatment.

Further elements such as line areas and especially preferably control lines for hydraulic oil are co-integrated in the region of the hydrodynamic component arranged integrally with the housing in a further, very appropriate arrangement of the invention.

The guidance of the lines for the required control medium can substantially be concentrated on the transmission housing and the components arranged integrally with the same. This reduces the number of connections and transfer points between the transmission housing and the functional element, e.g. the guide wheel. Further components can thus be avoided and respective work steps during mounting are saved. Finally, the integral arrangement with integrated lines is also less susceptible to leakages because fewer transfer points and thus fewer sealing points are required.

It can also be provided in an especially appropriate further development of the invention that the region of the hydrodynamic component which is arranged integrally with the transmission housing comprises hydraulic actuators, especially integrated pistons, in addition to the functional elements. These integrated pistons, which are typically arranged in the part of the region arranged integrally with the transmission housing which faces away from the functional elements, can be used for controlling multi-disk clutches and/or jaw couplings in the region of the transmission housing adjacent to the same. The advantages in this case too are the reduced number of components and the reduced number of transfer points and sealing points as well as simplified mounting because such actuators need not be mounted separately and fixed in the transmission.

As already mentioned, production via a casting process is considered for the arrangement of the transmission and its transmission housing in accordance with the invention. Accordingly, the preferred method for producing a transmission housing for a transmission in accordance with the invention is the casting in a permanent mold without any lost cores. From a certain limit piece number, this enables a considerably cheaper production than with respective casting methods with lost molds, especially sand casting, depending on whether an at least two-part gravity die or a die-casting mold is used as a permanent mold. Furthermore, better surface qualities and better material strength can be realized, so that further savings especially in the after-treatment of the cast components are possible.

Further advantageous developments of the invention are given in the remaining sub-claims and the embodiments which will be explained below by reference to the drawings by way of examples, wherein:

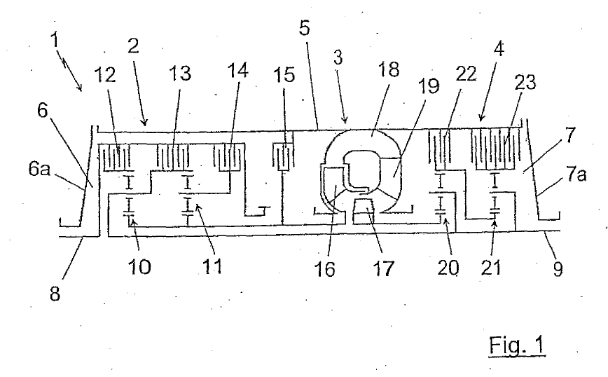

FIG. 1 shows a possible embodiment of a transmission with power splitting by a hydrodynamic converter according to the state of the art;

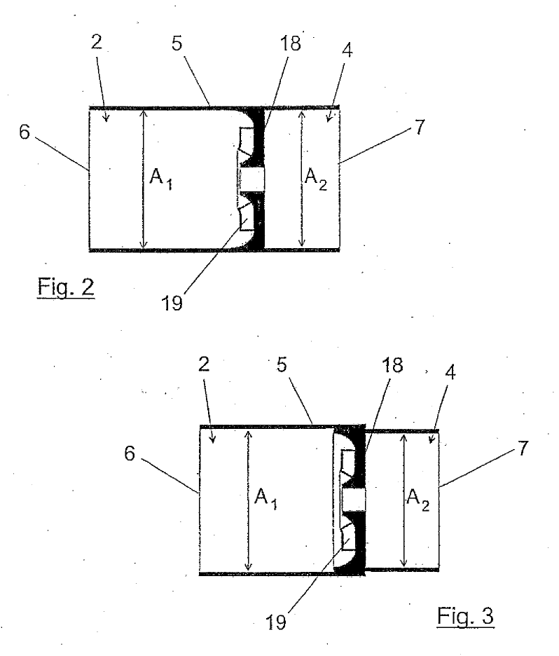

FIG. 2 shows a first possible embodiment of a transmission housing for the transmission in accordance with the invention, and

FIG. 3 shows a second possible embodiment of a transmission housing for the transmission in accordance with the invention.

FIG. 1 shows a typical hydrodynamic/mechanical automatic transmission 1. The transmission is substantially arranged symmetrically, which is why only half the transmission is shown here. The transmission 1 comprises an input area 2, the hydrodynamic converter 3 and an output area 4, which are all arranged in a housing 5. It is arranged in a substantially tubular way. The two openings 6, 7 of the substantially tubular transmission housing 5 are sealed via respective “covers” 6a, 7a or flanged onto corresponding components in such a way that they “cover” the openings in a respective fashion. The input area is disposed on the side of the hydrodynamic converter 3 which faces the transmission input 8. The output area 4 is accordingly disposed on the side of the hydrodynamic converter 3 which faces the transmission output 9. The arrangement of the input area 2 is one that is conventional according to the state of the art, which comprises two planetary gear sets 10, 11 and respective multi-disk clutches 12, 13, 14, via which various gear ratios can be set. As is common practice in hydrodynamic/mechanical transmissions 1, power can further be transferred via the hydrodynamic converter 3, which will typically occur during starting in the first gear. The hydrodynamic converter can be triggered via a multi-disk brake 15 in the input area 2 in such a way that a pump wheel 16 of the hydrodynamic converter 3 can be braked or released via this multi-disk brake 15. Power is transferred onto a turbine wheel 17 via the pump wheel 16 in the case of utilizing the hydrodynamic converter, which turbine wheel guides the power to the output area 4. Furthermore, the hydrodynamic converter 3 has a guide wheel 18 with respective guide blades 19, which guide wheel is fixed in relation to the housing 5. Two planetary gear sets 20, 21 are shown in the output area 4 of transmission 1, which planetary gear sets can be used together with two multi-disk clutches 22, 23 for the forward and reverse gear and the brakes.

This arrangement of transmission 1 corresponds to the state of the art. The arrangement of the input area 2 and the output area 4 is chosen in a merely exemplary manner. It is also possible to arrange the input area 2 and the output area 4 differently. It is also possible to arrange the same differently, so that the converter or an alternative or additional hydrodynamic component such as a hydrodynamic coupling or retarder is not arranged in a mandatory fashion between the output area 2 and the input area 4. It could also be disposed on one side of the further components arranged in the transmission. As already mentioned, alternative arrangements of the input area 2 and the output area 4 are possible. Reference is hereby made in an exemplary way to an output area and/or an input area with merely one planetary gear set, as is known for example from DE 10 2008 010 064 or DE 10 2008 027 947.

FIG. 2 shows a transmission housing 5 for a transmission 1 in accordance with the present invention. The arrangement of the transmission and the size of the transmission, the number of the multi-disk clutches or jaw couplings and the number of planetary gear sets is irrelevant because the arrangement of the transmission housing 5 is relevant here. The transmission housing 5 comprises a part arranged integrally with the transmission housing 5 as a functional element of the hydrodynamic converter 3. This component is in this case, which is shown by way of example, the guide wheel 18 with the guide blades 19. The guide wheel 18 with its integrally arranged guide blades 19 is also arranged to be integral with the housing 5 of the transmission. The inner cross section A₁ which lies between the guide wheel 18 and the opening 6 of the transmission housing 5 is arranged in such a way that it is arranged to be the same over the path between guide wheel 18 and opening 6 when starting out from guide wheel 18 and to be arranged in an expanding way in the region of the connection of the guide wheel 18 to the transmission housing 5, as seen from the guide wheel 18. The inner cross section A₂ between the guide wheel 18 and the opening 7 of housing 5 is arranged with constant cross section. Undercuts occur neither in the cross section A₁ of the input area 2, nor in the cross section A₂ of the output area 4.

This development of the transmission housing 5 with the integrated guide wheel 18 thus allows the production of the transmission housing 5 via a casting method in a permanent mold, e.g. a gravity die. The gravity die can be arranged to be provided in at least two parts, with a first part protruding into the area of the inner cross section A₁, whereas the other part protrudes into the area of the inner cross section A₂. Since the cross sections do not decrease from the molded guide wheel 18 in the directions of the openings 6 and 7, which means that no undercuts occur, a very simple demolding from the gravity die can occur in such a way that the two halves of the gravity die (not shown here) are moved away from one another. Other than in the developments according to the state of the art, no additional cores are necessary here which typically would need to be realized as sand cores.

The development of the inner cross sections A₁, A₂ of the transmission housing 5 and the thus achieved simple demoldability allows producing the transmission housing 5 in a gravity die or, when justified by the respective piece numbers, a die. Respective molds made of steel or steel gravity dies can be used with the typically used material, e.g. a light-metal alloy, especially on the basis of aluminum or magnesium. In addition to the cost advantages over sand casting, they offer the advantage that the surfaces of the cast parts have a comparatively high quality, so that laborious after-treatment and the like can be omitted, especially in the area of the guide blades 19. Moreover, a comparatively fast cooling of the melt in the region of the surface is achieved by the rapid heat dissipation via the gravity die which offers good thermal conductivity, so that a respectively fine structure is obtained which has a comparatively high strength.

Furthermore, a part of the hydraulic component, which is the converter 3 here for example, can be realized together with the transmission housing. It therefore does not have to be produced as a separate component, so that a die for this component is not necessary. Furthermore, the component does not have to be mounted in the transmission housing 5, so that it is neither necessary to realize either respective receivers such as screwed joints or the like, nor is it necessary to have the respective mounting work in the production of the transmission 5.

Furthermore, additional connections between the guide wheel 18 and the housing 5 can be omitted, which again reduces the total number of installed parts and thus the costs. Similarly, transfer points of lubricating oil for the bearing can be integrated in the guide wheel 18 and thus in the transmission housing 5. Since lubricating oil and control oil lines extend anyway in the transmission housing 5, they can be combined directly with the lines extending in the guide wheel 18, so that no transfer points are necessary which need to be connected with one another by respective components and need to be sealed against the ambient environment.

Furthermore, the arrangement and representation of the guide wheel blades 19 of guide wheel 18 in particular by casting in the gravity die and the subsequent omission of after-treatment grants a high amount of constructional freedom. The guide blades can be adjusted ideally to the hydrodynamic requirements because they no longer need to be designed in such a way that subsequent machining of all relevant points is enabled.

FIG. 3 shows a further alternative embodiment, which shows that the development shows certain freedoms despite the inventive requirements concerning the cross sections A₁, A₂, because an additional shoulder is provided in the region of the connection of the guide wheel 18 and a reduction of the outside diameter of the transmission housing 5 in the region of the output area 4. These developments do not limit the demoldability, but are optionally very helpful with respect to the design freedom in the arrangement of the transmission because sealing can occur very easily in respective edges.

The guide wheel 18 in the exemplary illustration of FIGS. 2 and 3 shows a configuration which deviates from that in FIG. 1. In order to realize a respective demoldability in the region of the input area 2, the shape of the converter on the housing side does not protrude again into the interior region of the input area 2 on its sides opposite of the guide blades 19, which differs from the configuration according to the state of the art as shown in FIG. 1. This is a concession made to the demoldability of the housing 5 in the casting process, but does not represent any disadvantage from a hydrodynamic standpoint. It is rather possible to arrange the pump wheel 16 up to the area of the outside diameter of the input area at the transitional point to the guide wheel 18, so that the rotating pump wheel 16 will form the complement of the hydrodynamic converter 3. Such a configuration can be optimized accordingly due to the high amount of design freedom of the guide blades 19. As an alternative to this, a fixed ring could also be mounted in this area.

In addition to the already mentioned components for guiding lubricating oil and hydraulic oil, further elements can be integrated in an integral manner in the housing 5 and/or the guide wheel 18. It would especially be possible to integrate actuators, especially pistons, for actuating the multi-disk brakes, especially in the output area 4 on the side of the guide wheel 18 facing the opening 7, which is in its rear side. These actuators which could then be used for actuating the multi-disk brakes 22 could be supplied with the respective control pressures via the transmission housing 5 and the guide wheel 18 which is arranged with the same in an integral manner, so that in this case too it is possible to save components and transfers points that are critical with respect to leakages.

The respective arrangement of the transmission housing 5 with its demoldability and the possibility of integrating further elements such as line elements and/or actuators in an integral manner with the housing or the guide wheel 18 enables a very efficient and cost-effective configuration. It is merely necessary to mount parts in the transmission housing 5 which either need to be held rotatably or optionally need to be removed for maintenance purposes. The fixed functional elements are already integrated in a fixed manner in the transmission housing 5, so that the guide wheel 18 and the guide blades 19 can be produced with a single mold by gravity die casting or pressure die casting in an efficient and simple manner.

It is understood that it is also necessary to consider the demoldability of the outer diameter of the transmission housing 5 in addition to the demoldability of the inner cross sections A₁, A₂. Since this is known and common practice anyway in the state of the art, a detailed explanation of the constructional design will be omitted.

It is understood that another functional element fixed in the housing 5 could be used instead of the chosen illustration of the guide wheel 18 with the guide blades 19. It could be possible to arrange merely the guide wheel 18 with the transmission, whereas the guide blades 19 are inserted afterwards.

If the transmission 1 comprises a further hydrodynamic component, e.g. a second converter, a hydrodynamic coupling or a retarder, it could be co-integrated in the transmission housing 5 especially together with the functional element of the first hydrodynamic component. It would then make sense to arrange the two guide wheels of the two hydrodynamic components in an arrangement back-to-back and integrate them in the transmission housing 5. In the illustration of FIGS. 2 and 3 this would be such that on the side of the guide wheel 18 facing the opening 7 it would be possible to provide a respective shaping of the required guide wheel geometry, e.g. with further guide blades. A configuration would also be possible in this case as a result of the direct integral arrangement of the two guide wheels with one another in which no undercuts occur between the guide wheels, so that this configuration meets the requirements of the invention and can be cast in a simple and efficient way in a permanent mold without any additional cores.

1. A transmission, comprising
a transmission housing;
at least one hydrodynamic component;
at least one region of the hydrodynamic component which is integrally arranged with the transmission housing;
characterized in that
the transmission housing is arranged in a substantially tubular way with one opening at each end, with
the region of the hydrodynamic component which is integrally arranged with the transmission housing is arranged as a functional element of the hydrodynamic component, with
the functional element being arranged between the openings, and with
the inner cross section of the transmission housing being arranged to be constant or expanding from the functional element to the respective opening.

2. A transmission according to claim 1, characterized in that the hydrodynamic component is a hydrodynamic converter.

3. A transmission according to claim 1, characterized in that the at least one functional element of the hydrodynamic component is a guide wheel.

4. A transmission according to claim 1, characterized in that the guide wheel comprises guide wheels in an integral manner.

5. A transmission according to claim 1, characterized in that the region of the hydrodynamic converter which is arranged integrally with the transmission housing comprises line areas, especially control lines for hydraulic oil, in addition to the at least one functional element.

6. A transmission according to claim 1, characterized in that the region of the hydrodynamic converter which is arranged integrally with the transmission housing comprises hydraulic actuators, especially pistons, in addition to the at least one functional element.

7. A transmission according to claim 1, characterized in that the region of the hydrodynamic converter which is arranged integrally with the transmission housing comprises two functional elements which are arranged in such a way that their functional sides face the respective opening.

8. A transmission according to claim 1, characterized in that the transmission housing is made of a light-metal alloy.

9. A transmission according to claim 8, characterized in that the light-metal alloy is arranged on the basis of aluminum.

10. A transmission according to claim 8, characterized in that the light-metal alloy is arranged on the basis of magnesium.

11. A method for producing a transmission housing for a transmission according to claim 1, characterized in that the transmission housing is cast with a permanent mold without any lost cores.

12. A method according to claim 11, characterized in that at least a bipartite gravity die is used as a permanent mold, in which the liquid melt is cast.

13. A method according to claim 11, characterized in that an at least bipartite die-casting die is used in which the liquid melt is pressed.

14. A transmission according to claim 2, characterized in that the at least one functional element of the hydrodynamic component is a guide wheel.

15. A transmission according to claim 2, characterized in that the region of the hydrodynamic converter which is arranged integrally with the transmission housing comprises line areas, especially control lines for hydraulic oil, in addition to the at least one functional element.

16. A transmission according to claim 3, characterized in that the region of the hydrodynamic converter which is arranged integrally with the transmission housing comprises line areas, especially control lines for hydraulic oil, in addition to the at least one functional element.

17. A transmission according to claim 4, characterized in that the region of the hydrodynamic converter which is arranged integrally with the transmission housing comprises line areas, especially control lines for hydraulic oil, in addition to the at least one functional element.

18. A transmission according to claim 2, characterized in that the region of the hydrodynamic converter which is arranged integrally with the transmission housing comprises hydraulic actuators, especially pistons, in addition to the at least one functional element.

19. A transmission according to claim 3, characterized in that the region of the hydrodynamic converter which is arranged integrally with the transmission housing comprises hydraulic actuators, especially pistons, in addition to the at least one functional element.

20. A transmission according to claim 4, characterized in that the region of the hydrodynamic converter which is arranged integrally with the transmission housing comprises hydraulic actuators, especially pistons, in addition to the at least one functional element.
